(19) United States
(12) Patent Application Publication
(10) Pub. No.: US 2024/0328603 A1
(43) Pub. Date: Oct. 3, 2024

(54) Replaceable Light Emitting Diode (LED) Module

(71) Applicant: Eaton Intelligent Power Limited, Dublin (IE)

(72) Inventors: Chunhuai Wang, Shanghai (CN); Peihuan Liu, Shanghai (CN); Yuru Li, Shanghai (CN)

(21) Appl. No.: 18/622,129

(22) Filed: Mar. 29, 2024

(30) Foreign Application Priority Data
Mar. 31, 2023 (CN) 202320694280.5

(51) Int. Cl. F21V 17/00; F21V 5/00; F21V 17/16; F21V 29/77; F21V 31/00; F21Y 113/00; F21Y 115/10

(52) U.S. Cl. CPC F21V 17/002; F21V 5/007; F21V 17/162; F21V 29/773; F21V 31/005; F21Y 2113/00; F21Y 2115/10

(57) ABSTRACT

In one embodiment, a LED module comprises a heat sink, a light source, a lens structure configured to enclose the light source by means of a sealing material, and a fastener assembly configured to removably attach the light source and the lens structure to the heat sink. The lens structure comprises a groove and one or more lenses. The groove surrounds the one or more lenses and is configured to receive the sealing material such that the sealing material seals a gap between the lens structure and the light source without attaching to the heat sink.

### PRIORITY

This application claims the benefit of Chinese Utility Model patent application Ser. No. 20/232,0694280.5, filed 31 Mar. 2023, which is incorporated herein by reference.

### TECHNICAL FIELD

The disclosure relates to the field of lighting equipment, and more particularly to a replaceable light emitting diode (LED) module that can be used in a LED assembly.

### BACKGROUND

LED lightings have been applied in a wide variety of industries. Typically, in those environments, operational conditions are often harsh and complicated, making it especially challenging to perform service procedures such as replacement of LED equipment. At present, the current LED designs use adhesive material for binding lighting component with heat sink to form LED assembly, resulting that, in case of lighting malfunction or failure, or when a maintenance service is needed, the entire LED assembly is required to be removed and replaced. However, it may be inconvenient and sometimes difficult to perform such total replacement due to complexity of industrial environments in which the LEDs are often employed. Further, it may be costly and wasteful to discard the entire LED assembly particularly in situations where only the light source needs to be replaced and other components of the LED assembly remain functional.

Accordingly, there is a need to achieve a LED module that can be reliably secured in a LED assembly and at the same time permits individual replacement of the LED module.

### SUMMARY OF PARTICULAR EMBODIMENTS

This disclosure provides a LED module that may advantageously be configured as an integral part and detachably mounted for example to a fixture structure of a LED assembly, thereby enabling simple replacement of the LED module without requiring removing the fixture or replacing the entire LED assembly. A fastener assembly utilized by the LED module of this disclosure may facilitate such benefit of convenient replacement and moreover provide structural reinforcement to fragile components of the LED module against load concentration that, for example, may be induced during operation, thus allowing the LED module to be secured in place in a replaceable and reliable manner.

An embodiment of the LED according to this disclosure comprises a heat sink, a light source attached to the heat sink and comprising one or more lighting elements coupled to a board, a lens structure configured to enclose the light source by means of a sealing material, and a fastener assembly configured to removably attach the light source and the lens structure to the heat sink. The lens structure comprises a groove and one or more lenses. The groove surrounds the one or more lenses and is configured to receive the sealing material such that the sealing material seals a gap between the lens structure and the board of the light source without attaching to the heat sink.

In particular embodiments, the fastener assembly comprises one or more clamping plates.

In particular embodiments, the fastener assembly further comprises a plurality of fasteners.

In particular embodiments, the one or more clamping plates are configured to be interposed between the plurality of fasteners and the lens structure and provide a relatively large clamping area for the lens structure.

In particular embodiments, the one or more clamping plates are made of metal.

In particular embodiments, the fastener assembly is configured to removably attach the lens structure and the light source to the heat sink along a periphery of the lens structure.

In particular embodiments, the fastener assembly is configured to removably attach the lens structure and the light source to the heat sink near a center of the lens structure.

In particular embodiments, the lens structure further comprises another groove positioned near a center of the lens structure and configured to receive the sealing material.

In particular embodiments, the lens structure further comprises one or more ribs positioned within at least one of the grooves.

In particular embodiments, the lens structure and the light source form as a replaceable unit.

### BRIEF DESCRIPTION OF THE DRAWINGS

Embodiments of this disclosure are described in detail below in combination with drawings.

FIG. 1 depicts an exploded view of an example LED assembly incorporating an embodiment of a LED module according to this disclosure.

FIG. 2 depicts a cross-sectional view of an example LED assembly incorporating an embodiment of a LED module according to this disclosure.

FIG. 3 depicts a top view of an example LED assembly incorporating an embodiment of a LED module according to this disclosure.

FIG. 4 depicts a top view of an embodiment of a LED module according to this disclosure.

FIG. 5 depicts a top view of an embodiment of a lens structure of a LED module according to this disclosure.

### DESCRIPTION OF EXAMPLE EMBODIMENTS

This disclosure presents a LED module suitable to be mounted in a LED assembly. In particular, the LED module according to this disclosure utilizes a fastener assembly that may removably attach the LED module to a mounting fixture in a simple and convenient way. In addition, the fastener assembly may provide mechanical enhancement so as to avoid structural damage (for example, cracks and fractures) to the LED module that may otherwise result from thermal expansion/contraction or fastening procedure. Further, various components such as a LED light source and a lens of the LED module may be encapsulated together to form as a replaceable unit, such that in the event of malfunction or when a service is needed, the LED module as a whole may be easily separated from other components of the LED assembly. The design of the LED module disclosed herein enables efficient mounting and/or replacement since the LED module can be attached and detached independent of the fixture structure or other parts of the LED assembly, thereby making the manufacturing and maintenance processes easier and more cost effective and prolonging the service life of the LED assembly.

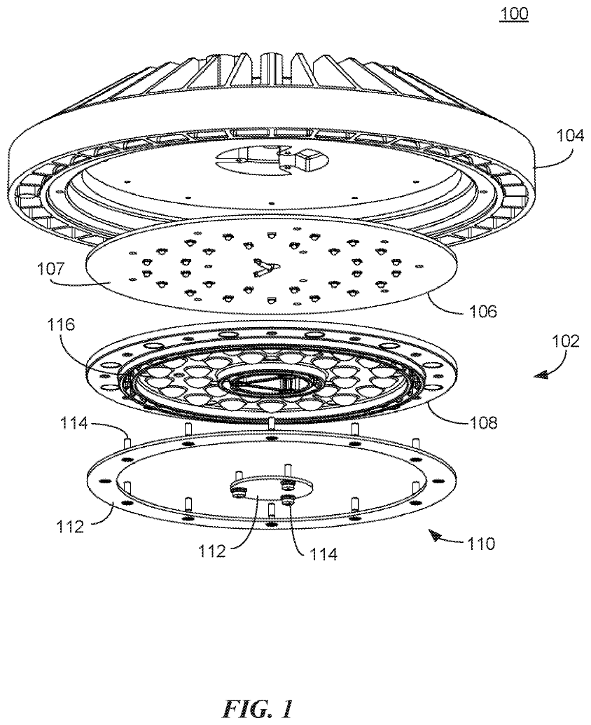

FIGS. 1-3 illustrates an example LED assembly 100 incorporating an embodiment of a LED module 102 of this disclosure. For example, the LED assembly 100 may be suitable for pendant lighting or other suitable lighting functions such as flood lighting or the like. In particular embodiments, the LED assembly 100 may comprise a mounting fixture such as a heat sink 104 and a LED module 102 that may be coupled to the heat sink 104. For example, the heat sink 104 may be configured to provide mechanical support as well as electrical connection for the LED module 102. The LED module 102 of this disclosure may be secured to the heat sink 104 in a removable way so as to facilitate mounting and/or detaching the LED module 102 and simplify replacement of the LED module 102 in case of lighting malfunction or failure. Furthermore, because the LED module 102 of this disclosure can be replaced independent of other components (e.g., heat sink 104) of the LED assembly 100, service and maintenance operation of the LED assembly 100 can be performed in a much easier and cheaper way.

With reference to FIG. 1, in some embodiments, in addition to accommodating the LED module 102, the heat sink 102 may also enable heat dissipation for various heat producing components during operation. As an example and not by way of limitation, the heat sink 104 may be made of aluminum or other suitable material familiar to those skilled in the art for achieving desired thermal conduction. As shown in the example of FIG. 1, the heat sink 104 is formed as a frustoconical structure that comprises a bottom base, which defines on its bottom surface a circular cavity suitable for receiving various components (e.g., the LED module 102), and multiple heat dissipation fins surrounding the bottom base. As an example and not by way of limitation, the heat dissipation fins may be tapered in shape and arranged around the bottom base in a circumferential direction at a proper distance with respect to each other in a way that forms multiple spacings therebetween. In this way, the spacings may be used to absorb heat generated for example by the LED module 102 and enable convective cooling by multiple thermal flow channels formed in the spacings.

In particular embodiments, as shown in FIG. 1, the cavity of the heat sink 104 may be configured for positioning the LED module 102 or other components associated with the LED assembly 100. As an example and not by way of limitation, bottom surface of the cavity supporting the LED module 102 may be provided with multiple mounting features, such as threaded holes, unthreaded holes, bores, or the like, so as to facilitate securing of the LED module 102 to the heat sink 104 in a removable way. In addition, the bottom surface of the cavity may also comprise a through hole arranged near the center of the cavity or at other suitable locations. For example, the through hole may be configured for receiving a cable, a conducting wire, or other similar connection features, such that when the LED module 102 is mounted in the cavity, a cable passing through the through hole may be conductively coupled to the LED module 102 for supplying electric power to the LED module 102. In some embodiments, side walls of the cavity may be constructed as a step-like configuration that snugly fits with the outer contour of the LED module 102 when the LED module 102 is mechanically attached to the cavity, thereby providing stable structural support to the LED module 102. It is appreciated that the heat sink 104 described herein is merely exemplary, other suitable configurations and functionalities may be apparent to those skilled in the art and are not explained in exhaustive details by this disclosure.

In particular embodiments, the LED module 102 may be removably contained within the cavity of the heat sink 104 in a manner to allow for individual replacement of the LED module 102 without requiring removing the heat sink 104 or replacing the entire LED assembly 100. In this way, replacement of the LED module 102 can be achieved much more easily and conveniently. Moreover, by forming the LED module 102 as a removable unit without permanent fixation to the heat sink or other fixture structure, product design as well as maintenance procedure of the LED assembly can be significantly simplified and at a lower cost. Although depicted as being received by the heat sink 104, this disclosure contemplates other suitable supporting structures familiar to those skilled in the art for securing the LED module 102. For example, a LED lighting fixture may be provided for removably holding the LED module 102 in place.

With reference to FIGS. 1-4, in particular embodiments, the LED module 102 may comprise a light source 106, a lens structure 108, and a fastener assembly 110, which will be described in greater detail below.

In particular embodiments, the light source 106 of the LED module 102 may comprise a board such as a printed circuit board 107 having multiple lighting clements (c.g., LEDs) electrically connected thereon and arranged as a circular array. Of course, the light source 106 may include other suitable components familiar to those skilled in the art for providing lighting function as desired. In the example as depicted through FIGS. 1-4, the light source 106 may be shaped as a disk that is suitable to be received in the circular cavity of the heat sink 104. In particular embodiments, center portion of the light source 106 may be provided with an electrical contact, an electrical lead, or other suitable wiring components, which may be conductively coupled to one end of the corresponding cable located within the through hole of the heat sink 104 for establishing electrical connection when the LED module 102 is mounted in place. Moreover, in particular embodiments, the light source 106 may comprise multiple through holes which, as more clearly illustrated in FIG. 1, are positioned near an outer perimeter of the printed circuit board 107 and configured to be align with the mounting holes of the heat sink 104 during assembly.

Referring to FIGS. 1-4, in particular embodiments, the lens structure 108 of the LED module 102 may generally take form as a disk that corresponds to the shape of the light source 106 and may be configured for enclosing the light source 106 in a seal tight manner, thereby both mechanically and electrically isolating electronic parts of the lens structure 108 from the external environment. Furthermore, the lens structure may have a transparency suitable for light beam emanating from the light source 106 to pass through. As an example and not by way of limitation, the lens structure 108 may be made of plastic, glass, or other suitable material for achieving the desired function of this disclosure.

In the example embodiment of FIGS. 1-3, the lens structure 108 are provided with multiple through holes along the periphery of the lens structure 108 and positioned to be in line with the corresponding through holes of the light source 106 and/or the mounting holes of the heat sink 104, respectively, so as to facilitate mounting. Additionally, area surrounding the through holes may form a flat surface that is suitable for fastener structures to sit thereon, details of which will be explained further in the below.

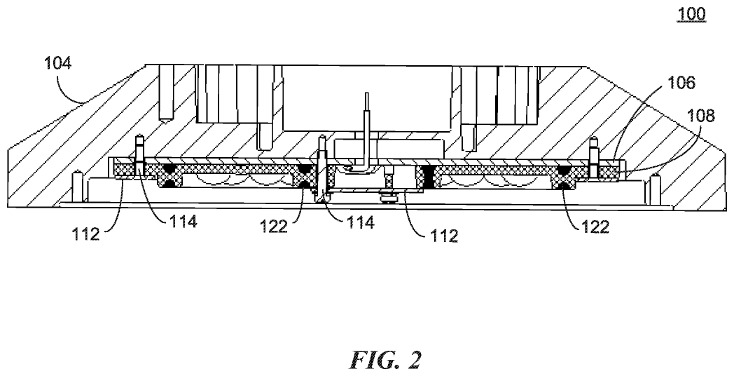

In particular embodiments, the lens structure 108 may comprise two annular grooves 116 arranged coaxially at the center of lens structure 108 and in a spaced-apart relationship from each other in a radial direction. In the embodiment as shown, one of the grooves may be positioned near the circumference of the lens structure 108, for example, in proximity to and radially inward with respect to the series of through holes, while the other groove may be centrally located. In particular embodiments, the grooves 116 may have a vertical depth that spans across the entire thickness of the lens structure 108 such that when the lens structure 108 is disposed on top of the light source 106, portions of the printed circuit board 107 of the light source 106 located underneath the lens structure 108 may be exposed by the grooves 116. In this way, the grooves 116 may be suitable for receiving a scaling compound (e.g., sealing compound 122) or other suitable sealant or adhesive material in order to tightly affix the lens structure 108 against the underlying printed circuit board 107 of the light source 106 and encapsulate the light source 106 in a sealed manner. In doing so, the lens structure 108 and light source 106 may be bonded into a unitary piece that can be mounted and/or removed as a whole. Additionally or alternatively, in some embodiments, as more clearly seen in FIGS. 1-2, one end of the groove 116 may stay flush with the surface of the lens structure 108 that contacts the light source 106, and the other end of the groove 116 may protrude beyond the opposite surface of the lens structure 108 in a way to provide a relatively large volume for receiving the sealing compound, thereby ensuring sufficient adhesion and scaling.

In some embodiments, the lens structure 108 may also include a centrally located opening, such that when placed above the light source 106, the center opening of the lens structure 108 may enable free access for example to the electrical contact or other electronic components positioned on the center portion of the light source 106.

Furthermore, in particular embodiments, the lens structure 108 may comprise multiple lenses, which can be positioned to be encircled by one of the grooves 116 (e.g., the outer groove). This can be observed more clearly in FIG. 1. The lenses may have a shape conforming to the outer contour of the lighting elements and are similarly positioned as a circular array in order to provide individual spaces for housing each of the lighting elements. As an example and not by way of limitation, the lenses may be formed integrally with the lens structure 108 as a single structure, or separately depending on manufacturing process.

In particular embodiments, as depicted in FIGS. 1-4, the LED module 102 may further comprise a fastener assembly that may be configured to removably couple the light source 106 and the lens structure 108, for example, to the cavity of the heat sink 104. It is appreciated that other locations are also contemplated by this disclosure for removably attaching the LED module 102. In particular embodiments, the fastener assembly 110 may comprise multiple fasteners 114 and one or more clamping plates 112 configured for positioning and receiving the fasteners 114. In the example embodiment shown in FIGS. 1-4, the multiple clamping plates 112 comprise a center clamping plate and an outer clamping plate. The center clamping plate may take form as a circular plate, which when mounted, may be positioned above the center of the lens structure 108. For example, in the embodiment where the lens structure 108 is provided with a central opening, the center clamping plate may be fastened above the central opening, thereby protectively covering center portion of the light source 106 that is located below the lens structure 108 and exposed by the central opening. As depicted, the outer clamping plate may be shaped as an annular ring that is concentric with the center clamping plate and configured to fit along the perimeter of the lens structure 108. For example, the outer clamping plate may be pressed tightly against the flat surface near the peripheral edge of the lens structure 108 so as to provide sufficient sealing and securement. Although depicted as having two clamping plates, the fastener assembly 110 of this disclosure may comprise any suitable number of clamping plates for achieving the function described herein.

In particular embodiments, cach of the clamping plates 112 may comprise multiple spaced- apart through holes for receiving the fasteners 114. For example, the through holes may be threaded holes, unthreaded holes, bores, or the like familiar to those skilled in the art. In particular embodiments, the clamping plates 112 and the fasteners 114 may be made of metal or other suitable materials for securely attaching the lens structure 108 and the light source 106 to the heat sink 104. In this case, the clamping plates 112 may serve like a gasket and provide for large clamping area between the fasteners 114 and the lens structure 108 in a way that effectively distributes stress built up around the through holes (for example, due to snug insertion of the fasteners 114) and effectively prevents microfracture of or damage to the lens structure 108 especially if the lens structure 108 is made of plastic or other materials having weaker mechanical characteristics than the fastener assembly 110.

In particular embodiments, the fastener 114 of the fastener assembly 110 may be a screw, a bolt, a pin, or other suitable features for providing mechanical fixation. For example, as already described above and with reference to FIGS. 1-4, the clamping plates 112, the lens structure 108, and the light source 106 may each be provided with multiple through holes that may be threaded or configured otherwise to receive the fasteners 114 (c.g., screw). As an example and not by way of limitation, during assembly, the fasteners 114 may be first inserted into the through holes of the clamping plates 112, pass through the respective through holes of the lens structure 108 and the light source 106, and finally into the mounting holes located at the bottom surface of the cavity of the heat sink 104 so as to detachably connect the LED module 102 to the heat sink 104, thus forming the entire LED assembly 100. When the LED module 102 needs to be removed for example for maintenance purposes, the fasteners 114 may be unscrewed to loosen cach of the clamping plates 112, thereby allowing the lens structure 108 and the light source 106 which are glued together to be removed as a replaceable unit. Alternatively, the center clamping plate may be individually released in order to enable access to electrical components such as the electrical contact arranged near the center of the printed circuit board 107 of the light source 106. It is appreciated that although the disclosure describes the fastener assembly 110 as using a screw-and- threaded-hole combination, other suitable features are also contemplated for removably mounting the lens structure 108 and the light source 106 in place, such as by snap-fit or the like familiar to those skilled in the art.

Accordingly, by mechanically mounting the LED module 102 to the heat sink 104, the fastener assembly 110 of this disclosure can achieve reliable fixation even when the LED module 102 and the heat sink 104 undergo thermal expansion and contraction at different rate during operation, which, for example, may be caused by different thermal properties of materials consisting various LED components (e.g., the lens structure may be made of plastic, while the heal sink may be made of aluminum). In addition to ensuring such reliable securement throughout the operation cycle, the fastener assembly 110 of this disclosure can advantageously be easily removable, thereby allowing releasing various components so as to facilitate replacement of the LED module 102 in a convenient and time-efficient manner, which is especially beneficial given the complexity of operational conditions in which LED equipment are typically employed.

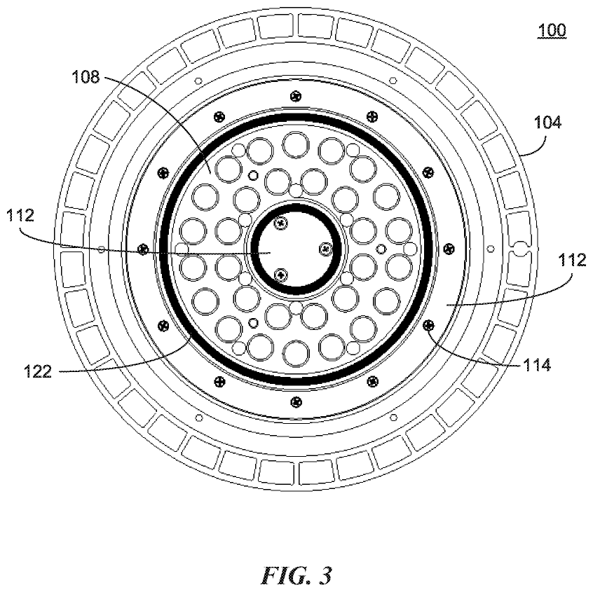

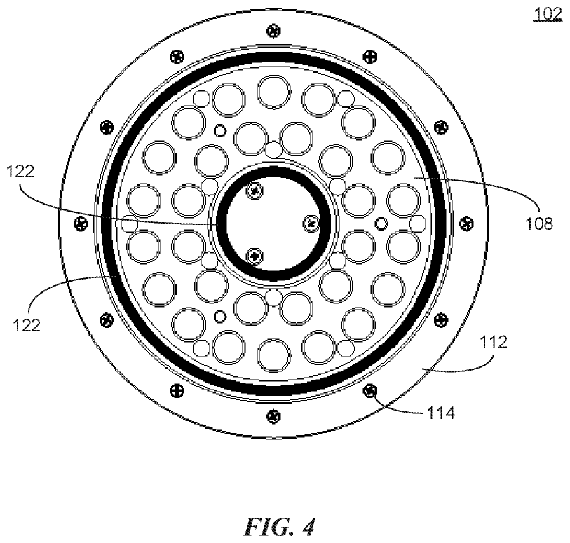

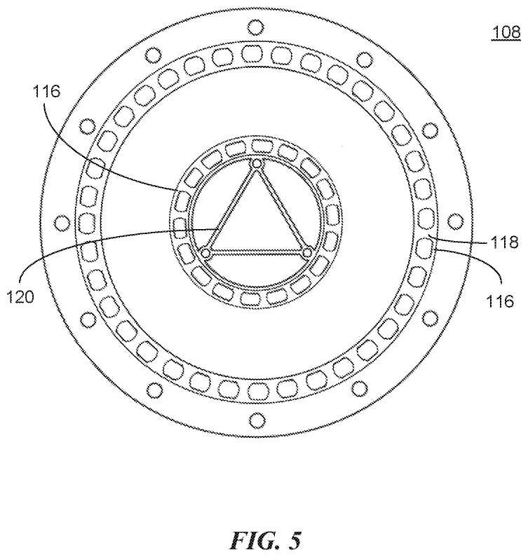

FIG. 5 illustrates an example lens structure 108 in accordance with this disclosure, more specifically delineating structures associated with the grooves and the center opening. In particular embodiments, multiple ribs 118 may be positioned within each of the two grooves 116 so as to provide for reinforcing structures. As an example and not by way of limitation, the grooves 116 and the ribs 118 may be formed integrally with the lens structure 108, or separately as needed. In particular embodiments, the ribs 118 may span the groove 116 in a radial direction and be arranged at a certain distance from each other in a way to form spacing between each pair of the ribs 118. In this way, during assembly, the sealing compound 122 may be introduced through the groove 116 onto the exposed portions of the light source 106 and fill the space formed around the ribs 118, in order to firmly bind the lens structure 108 with the light source 106 in a seal tight manner. In other words, the sealing compound 122 may form two protective seal rings (shown as two bold circles in FIGS. 3 and 4) that completely isolate respective portions of the light source 106 from the outside. Moreover, the ribs 118 may substantially balance stress acting upon the lens structure 108, achieving the effect of improving overall capacity of load resistance and enhancing structural strength of the lens structure 108.

Additionally or alternatively, the lens structure 108 may comprise a supporting seat 120 as shown in FIG. 5. The supporting seat 120 may be arranged in the opening near the center of the lens structure 108 for holding the center clamping plate of the fastener assembly 110 in an axial direction. Although shown as having a triangular structure, the supporting seat 120 may be configured differently for providing stable support for the clamping plate 112.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

### List of Reference Numbers

100 LED assembly
102 LED module
104 heat sink
106 light source
107 printed circuit board
108 lens structure
110 fastener assembly
112 clamping plate
114 fastener
116 groove
118 rib
120 supporting scat
122 scaling compound

What is claimed is:

1. A LED module, comprising:
a heat sink;
a light source attached to the heat sink, the light source comprising one or more lighting elements coupled to a board;
a lens structure configured to enclose the light source by means of a sealing material, wherein the lens structure comprises a groove and one or more lenses, wherein the groove surrounds the one or more lenses and is configured to receive the sealing material such that the sealing material seals a gap between the lens structure and the board of the light source without attaching to the heat sink; and
a fastener assembly configured to removably attach the light source and the lens structure to the heat sink.

2. The LED module of claim 1, wherein the fastener assembly comprises one or more clamping plates.

3. The LED module of claim 2, wherein the fastener assembly further comprises a plurality of fasteners.

4. The LED module of claim 3, wherein the one or more clamping plates are configured to be interposed between the plurality of fasteners and the lens structure and provide a relatively large clamping area for the lens structure.

5. The LED module of claim 2, wherein the one or more clamping plates are made of metal.

6. The LED module of claim 1, wherein the fastener assembly is configured to removably attach the lens structure and the light source to the heat sink along a periphery of the lens structure.

7. The LED module of claim 1, wherein the fastener assembly is configured to removably attach the lens structure and the light source to the heat sink near a center of the lens structure.

8. The LED module of claim 1, wherein the lens structure further comprises another groove positioned near a center of the lens structure and configured to receive the sealing material.

9. The LED module of claim 8, wherein the lens structure further comprises one or more ribs positioned within at least one of the grooves.

10. The LED module of claim 1, wherein the lens structure and the light source form as a replaceable unit.
